(19) United States
(12) Patent Application Publication
(10) Pub. No.: US 2013/0045651 A1
(43) Pub. Date: Feb. 21, 2013

(54) INTEGRATED, WASHABLE AND REUSABLE THREE-DIMENSIONAL (3D) MULTIFUNCTIONAL KNITTED FABRIC STRUCTURE AND METHOD TO PRODUCE THE SAME

(71) Applicants: Raul Manuel Esteves De Sousa Fangueiro, Braga (PT); Hélder Filipe Da Cunha Soutinho, Braga (PT); Alberto Queiroga Figueiredo, Palmeira de Faro (PT); Carla Marina Araújo Pires, Braga (PT)

(72) Inventors: Raul Manuel Esteves De Sousa Fangueiro, Braga (PT); Hélder Filipe Da Cunha Soutinho, Braga (PT); Alberto Queiroga Figueiredo, Palmeira de Faro (PT); Carla Marina Araújo Pires, Braga (PT)

(73) Assignee: IMPETUS PORTUGAL - TEXTEIS SA, Apulia (PT)

(21) Appl. No.: 13/582,910

(22) PCT Filed: Mar. 5, 2010
(86) PCT No.: PCT/PT2010/000008

§ 371 Date: Nov. 2, 2012

(51) Int. Cl. B32B 5/06; B32B 5/26; D04B 9/12; D04B 1/22; D04B 9/08

(52) U.S. Cl. 442/108; 66/196; 66/202; 66/19; 66/92; 442/59

(57) ABSTRACT

This invention provides a three-dimensional (3D) multifunctional knitted fabric structure comprising two independent layers (1 and 3) connected by cross-threads (2) being able to be applied as absorbency structure in medium incontinence men's reusable underwear. The structure is produced in a single step using weft-knitting technology and designed to perform several functions in a single fabric. The inner layer (1), to be in contact with human body, is responsible to transport liquid, urine and perspiration from the human body to the outer layer (3), through the cross-threads (2), keeping dry the human skin. Cross-threads (2) are responsible to keep apart both independent layers and to transport liquid from the inner layer (1) to the outer layer (2). The outer layer (3) is responsible to absorb the liquid and, at same time, to control the odor and microorganisms proliferation generated by the urine. The outer layer (3) is coated or laminated (4) with a moisture control polyurethane in order to prevent liquid passage to the user paints and at same time to provide vapor transmission.

### FIELD OF THE INVENTION

The present invention relates to a three-dimensional (3D) multifunctional knitted structure, produced in a single step using weft-knitting technology, comprising two independent layers connected by cross-threads specially engineered to perform several functions as absorbent structure of medium incontinence men's reusable underwear, including liquid transportation, dry skin, anti-odor and anti-bacterial.

### BACKGROUND OF THE INVENTION

Textile structures play an important role in the performance of the global textile system. Three-dimensional structures (3D) are organized and integrated set of fibers with multiaxial orientation. Due to the different orientations of the fibers, this type of structures presents a high performance behavior being suitable for a wide range of applications, such as multifunctionality (different functions in different layers), resiliency and porosity.

Three-dimensional (3D) fabrics may be produced using the most common textile techniques including braiding, nonwovens, weaving or knitting. Three-dimensional (3D) fabrics may be divided into solid three-dimensional (3D) structures or near-net-shaped three-dimensional (3D) structures. Three-dimensional (3D) solid fabrics are usually composed by two separate layers interconnected by piles or new textile structures. These types of structures are commonly used as reinforcements for composite materials due to their good delamination resistance and impact properties. In the last few years, great efforts have been performed in warp knitting technology to produce a wide range of three-dimensional (3D) fabrics being able to be applied in several conditions, like car seat foam replacement. Materials used in these types of structures are mostly polyester, either texturized or monofilament yarns. Fabrics produced are monomaterial based, varying just the type of pattern in each face and the density and yarn count of the interconnecting piles.

Urinary incontinence occurs when, the pressure inside the bladder exceeds the one existing inside the urethra, i.e., when a considerable increase in the pressure to urinate inside the bladder, during the filling micturition cycle. This incontinence may occur in any age but its causes tend to be different for each age range. Non-woven based materials are the most common textiles structures used as absorbent layer in men's medium incontinence underwear. Types of urinary incontinence include: stress, overfilling, total, psychogenic and mixed.

Products available in the market for men's urinary incontinence include: towels and napkins; underwear with place (pocket) to introduce napkins; underwear with fixed napkin; underwear with absorbent structure incorporated.

Both men and women depending on the urine volume and the number of urine loss may use towels and napkins. Normally several layers integrated separately in the same product compose these products. Usually are presenting a hydrophobic material close to the skin in order to keep it dry, normally in polyethylene, a cellulosic non-woven fabric based on high-absorbent pulp material in order to keep the urine released.

Underwear presenting a place (pocket) to introduce a napkin is mostly oriented for men. This is a normal underwear piece presenting a special pocket to introduce the napkin in contact with the genital area. The napkin used is normally a conventional one based on the materials described previously.

Other concept is provided by underwear with a fixed washable napkin oriented men, This product is basically composed by two components, the boxer rand the highly absorbable napkin. The basic construction used for the napkin is similar to that of the materials presented before.

Underwear with absorbent structure incorporated is other concept available especially for men urinary medium, incontinence. In this case, the product is composed by a boxer, which integrates in its construction a multilayer material with different functionalities, in special the absorbency function provided by a nonwoven layer integrated in the material.

U.S. Pat. No. 6,782,557, presents an underwear garment that provides protection against mild to moderate incontinence by using a layer of hydrophilic fabric placed in the absorption region. The fabric most commonly used will be sheared terry cloth. The terry cloth is treated with strongly hydrophilic polymer material to form a chemical barrier so that moisture will not readily pass through the cloth. The absorptive panel is then simply sewn into conventional underwear garments. This patent describes a product with a single function, absorption, based on the use of chemical treatments on a terry cloth with strong hydrophilic capability, while the invention described within this patent presents several functions in the same product without additional chemical treatments and is based on a completely different textile structure, in this case a three-dimensional weft-knitted fabric.

Patent JP2001025483 refers to underpants that prevent urinal leakage, less smelly and sweaty, hygienic and can be worn safely by an incontinent person. Underpants are made up a multilayer construction to provide several functions. Underpants are made up doubly of an interior and an exterior, the crotch portion of the interior is a double structure and a water-retaining portion is arranged in the inside touching the skin of the wearer and a water proof pan is covered with the exterior in the water-retaining portion, an activated carbon layer as a core is arranged, and a mesh fabric is arranged on the outer surface. The patent described relates to a multilayer material where the different layers are placed in sequence, without any fiber connection among them, to obtain the performance while in this invention the whole three-dimensional structure, inner layer, outer layer and cross-threads, are produced in a single step during the knitting process presenting fibers oriented in the through-thickness direction to provide liquid capillarity. Moreover, in the patent described above an activated carbon layer is used to perform odor control, while the present invention is using a fibrous material, knitted directly in the whole structure, to perform the same function.

Patent WO9200051 relates to a pair of underpants that are intended to support an incontinence guar or the like. The underpants include a front part which is intended to lie against the stomach of the wearer, a back part which is intended to lie against buttocks of the wearer, and a back part which is located between the front part and the back part and which is intended to be located between the wearer's thigh in use. The underpants also include a waist opening at the edges of the front and back parts, these openings being intended to embrace the wearer's thighs. The underpants have at least one incontinence guard-accommodating region. This patent relates just to underpants to accommodate an urine absorbing structure, while the present invention relates to the structure used to perform several functions in an incontinence underpants, including urine absorption, odor control, sealing, etc.

Patent JP2004283311 provides a pad for underpants for incontinence, which can peacefully and comfortably be continued to wear. The pad for incontinence is obtained by housing a net consisting of water repellent fibers or fibers to which water repellent work is performed and a water absorbing part of a multilayered structure in order from an upper side between two water-impermeable sheets whose peripheral parts are sealed with thermally welding or adhering to each other. The water absorbing part 6 is provided with a mesh body having a deodorizing function, This patent relates to a pad that is incorporated in underpants using a net. In the present invention the three-dimensional structure is a part of the underpants. Besides, the product described in the patent above is based on fibers placed in the same layer, while the present invention related to a three-dimensional structure with inner layer, outer layer and cross-threads.

Patent US2007277285 provides a personal comfort and multipurpose underwear/undergarment that includes, as an integral part thereof, a specially configured penis and genital pouch secured to the interior of the undergarment that includes a frontal elastic opening for receiving and comfortably securing a male penis, and coincident slit-like opening on the opposite side of the pouch to allow the penis to be easily and comfortably removed though the front panel of the undergarment. The undergarment significantly reduces the possibility of crushing or otherwise injuring the penis and/or genitalia during any sudden movement of the wearer, such us vigorous exercise occurring during sports activities. The pouch also serves to isolate the genitalia from the thigh area, so that in the humid conditions or conditions in which the wearer is perspiring due to physical activity, the penis and genitalia skin do not touch the wearer's thigh region. The patent above described presents an innovative system for penis protection while this invention regards to a multifunctional knitted structure for medium incontinence.

U.S. Pat. No. 6,323,388 presents a disposable absorbent article having a longitudinal direction and a lateral, cross direction. The article includes a liquid permeable top sheet layer, a substantially liquid impermeable back-sheet layer, and an absorbent structure having a primary retention portion sandwiched between the top sheet and back sheet layers. The retention portion includes a wet-formed mixture of fibers and super-absorbent material. The layers are bonded together to form the multilayer absorbent article. The patent described above regards to a disposable absorbent article comprising different layers without any specific connections, while the present invention is related to reusable three-dimensional structure for medium incontinence.

Patent US2006206085 refers to a men's reusable underwear with built-in absorbent panels. The underwear is fabricated from washable fabric formed into the pant. The pant has a front, a seat, a waistband and let openings. The form includes a first portion having an inner flap with an edge and a second portion having an outer flap with an edge. The flaps are situated in overlapping relation, sewn to the pant front at spaced locations, to define a normally closed fly. First and second panels are provided. Each of the panels includes a liquid absorbent layer and a liquid barrier layers. The panels are attached to the pant front, on opposite sides to the fly, with the edge of the first panel substantially co-extensive with the edge of the inner flap. The edge of the second panel may be substantially aligned with the edge of the outer flap, or spaced a short distance thereof, so as to form a substantially continuous liquid absorbent layer across the garment front. The patent above described relates to a multilayer structure wherein the different layers are connected at the edges by an additional process. Moreover, based in the absorbent capability, this invention presents a structure produced in a single step providing several functions like absorbency, odor control, and antibacterial.

Patent US2004097893 provides an absorbent product for men, having an absorption body which tapers from a front section of the product towards a crotch section of the product and which is enclosed in a sheath including a liquid-tight layer and a liquid-permeable layer, both of which layers extend beyond the absorption body round about this and are mutually joined there. This patent relates to an absorbent product that is enclosed in a sheath, while in the present invention the three-dimensional structure is a part of the underpants. Besides, the product described in the patent above is based on fibers placed in the same layer, while the present invention is related to a three-dimensional structure with inner layer, outer layer and cross-threads. Moreover, this patent just mentions a single function provided by the structure while the present invention provides several functions in the same structure.

U.S. Pat. No. 5,098,419 refers to an undergarment that retains urine and other body fluids comprising an upper, or body, portion made of a knitted fabric, and a lower, or crotch, portion made of a woven, non-woven or knitted fabric. The crotch portion is coated with a modified polyester urethane polymer, which prevents passage of body fluids, yet allows for some of the body condensate to escape, by moisture vapor transmission. Because the crotch material is coated, rather than laminated, the garment body and crotch portions can be assembles without using special sewing needles, methods or speeds. This patent relates to an underwear garment comprising two layers placed together for urine or body fluids absorption, while the present invention relates to a three-dimensional structure wherein the 3 layers are integrally produced and connected in a single step. Besides, the structure presented in the above-mentioned patent is a single function product while the present invention relates to a multifunctional product wherein each layer presents different functions.

The idea of combining the functions required for the application in men's incontinence underwear in a three-dimensional (3D) washable multifunctional knitted fabric has not been referred in the prior art. The systems described are always multilayered structures of fabrics comprising different materials to perform the required functions. Besides, it is possible to conclude that the type of structure used to integrate in the underwear is different in terms of fiber arrangement and multifunctionality. Most of the products described in the mentioned patents are using fabrics treated with hydrophilic polymer, while the present one is integrally produced in a three-dimensional (3D) multifunctional structure using weft-knitting technology. Besides the present invention includes also a coated or laminated polyurethane film applied to the outer layer.

Within this patent a novel multifunctional three-dimensional (3D) structure is provided to be integrated in underwear for men's medium urinary incontinence. Comparing the solution provided to those existing in the market and referred in the patents presented, different specifications might be identified for this invention:

single step production: all functions are integrated in the structure in a single step.

three-dimensional (3D) multifunctional structure: the layers composing the structure are fully integrated during the production process due to the use of connecting piles liking the independent layers;

multifunctionality: several functions in the some structure, as absorbent, odor control, antibacterial, shock absorption;

use of weft-knitting technology with proper adjustments.

### SUMMARY OF THE INVENTION

The present invention relates to a three-dimensional (3D) reusable multifunctional knitted fabric structure to be used as absorbent material in men's incontinence underwear. The structure comprises two independent functional layers (1 and 3) connected by cross-threads (4). The knitted inner layer (1) is to be contact with user's skin and it is produced with a hydrophobic fiber yarn, like polypropylene, polyester and polyamide, in order to transport the liquid and, simultaneously, give the dry sensation to the user. The cross-threads (2) keep the distance between both independent layers and, at same time, provide the liquid transportation from the inner layer to the outer layer thanks to the combination of hydrophobic and hydrophilic fiber yarns. The combination of hydrophobic and hydrophilic yarns is performed by switching these materials within the knitting process, i.e., varying the number of courses produced consecutively with hydrophilic material and with hydrophobic material. This sequence may be designed to control the absorption capacity and the dry sensation of the structure at the same time. The hydrophobic yarn is normally a monofilament, which can be knitted in the whole set of needles in both needle systems or just in half range. The monofilament yarn, due to its high stiffness plays a very important role to keep the distance between both inner and outer layers. The cross-threads may be knitted in all needles, in the cylinder and dial, in the case of circular knitting machines, and in front and back needles beds, in case of flat knitting machines, or just in preselected needles, in order to control the stiffness and the absorbing capacity of the structure. The outer layer (3) is responsible to keep the liquid transported from the inner layer through the cross-threads and at same time to control the odor and the microorganisms growing due to the retention of the urine. The material used in this case is a viscose based fiber treated with nanoparticles that will neutralize the ammonia contained in the urine and, at the same time, will inhibit the microorganisms to grow. In order to guarantee that the liquid is not passing through the outer layer, a breathable polyurethane coated or laminated layer (4) is used. This film is not allowing the urine to pass to the user's paints but at same time enables moisture evaporation. The thickness of this film may vary from 0,0001 cm to 2 cm. These three-dimensional (3D) knitted structures are produced in a single step, in several configurations according to dimensional properties (loop length, wales and courses per centimeter, etc) of the knitted fabrics of each layer, cross-threads density and fibers used. In outer and inner layers, the yarn count may vary from 2 to 200 tex, the number of courses and wales per centimeter may vary from 2 to 50, while the loop length may vary from 0,1 to 2 cm. In a preferred configuration the loop length in inner and outer layers is 0,37 cm, the yarn count in the inner layer is 8,4 tex and in the outer layer 20 tex, the number of wales and courses per centimeter is 8 in both layers, while the materials are polypropylene for the inner layer,, polyester viscose for the cross threads and viscose/deocell for the outer layer. This structure is intended to be integrated in an underwear boxer, in contact with the genital area, using sewing technology.

To obtain this three-dimensional (3D) multifunctional structure a special technique (FIG. 2) is used, based on double knitting system circular or flat weft-knitting technology. Within this technique different functional materials are fed to the equipment to produce simultaneously the inner and the outer layer, in the cylinder and in the dial respectively, in the case of circular knitting machines, and in the front and back needle bed respectively, in the case of flat knitting, connected by the cross-threads due to a combination of different types of loops performed in the dial and in the cylinder, or in the front and in the back needle bed, of the equipment. The knitting cycle (FIG. 2) starts with the production of the outer layer in the cylinder, in the case of circular knitting machines, or in the front needle bed, in the case of flat knitting. Then the functional yarn is fed the dial, in the case of circular knitting, or the back needle bed, in the case of flat knitting, producing the inner fabric layer. Finally, monofilament yarns are fed to produce tuck loops in half of the needles in each needle system, dial and cylinder, or front and back needle beds, in order to produce the connection between the two independent fabrics produced previously. Then the other half of needles that were not in action in the previous step are now fed by the monofilament yarn to complete the connecting layer. The functionalities of the 3D fabric thus produced may be designed according to the needs by selecting the appropriate functional yarns. These three-dimensional (3D) knitted structures are produced in a single step, using continuous process, in several configurations. In the production of this type of structures it is possible to use all types of fibers. The dimensional properties of each layer, composing the final 3D fabric structure, may be designed according to several factors like loop length, yarn linear density, type of fiber, yarn type, type of loops, etc. In outer and inner layers, the yarn linear density may vary from 2 to 200 tex, the number of courses and wales per centimeter may vary from 2 to 50, while the loop length may vary from 0,1 to 2 cm. The type of fiber for the inner layer may be polypropylene, polyester, polyamide, among others hydrophobic materials, while the yarn may be spun, texturized or multifilament. The cross threads may be based on a monofilament yarn of polyester, polyamide or polypropylene. The type of fiber used for the outer layer is based in viscose, cotton or other hydrophilic fibers, treated with anti-odor and antibacterial nanoparticles, and the correspondent yarn may spun, texturized or multifilament. The structure may be produced using the three types of loops available in weft-knitting technology, including normal, miss and tuck loops. These loops may be combined in each layer to provide different structure combinations.

The three-dimensional (3D) multifunctional knitted fabric produced within this technique presents important characteristics when comparing to other products currently used for men's incontinence underwear such as: reusability, easy and quick production, versatility according to thickness and dimensions required and performance. The men's incontinence underpants produced with the three-dimensional structure described within the patent are reusable which decreases the cost for the user when compared to the use of non-reusable pads. Besides, this structure is produced in a single step which decreases its total cost when compared to other solutions combining different layers. Moreover, the thickness of the three-dimensional structure may be designed to control comfort and performance in a range of 0,1 cm to 6 cm. The combination of loops to produce each layer may also be designed by combining different loops types in order to control the structure performance.

### DESCRIPTION OF THE DRAWINGS

FIG. 1 presents the cross-section of the three-dimensional (3D) multifunctional knitted structure. (1)—inner layer; (2)—cross-threads; (3)—outer layer; (4)—coated/laminated film.

FIG. 2 presents the knitting cycle to produce the three-dimensional (3D) multi-functional knitted structure. (5)—inner layer (hydrophobic material); (6)—outer layer (anti-odor material); (7)—cross-threads (monofilament material); (8)—cross-threads (hydrophilic material); (5)—inner layer (hydrophobic material); (9)—outer layer (hydrophilic material).

FIG. 3 presents the cross-section of the structure produced using the knitting cycle presented.

FIG. 4 presents the place (11) where the three-dimensional (3D) multifunctional structure will be applied in the men's underwear.

FIG. 5 presents the three-dimensional (3D) multifunctional knitted fabric (12) coated or laminated with a larger film (4).

FIG. 6 presents the dimensional properties for a preferred 3D multifunctional knitted fabric for men's underwear incontinence.

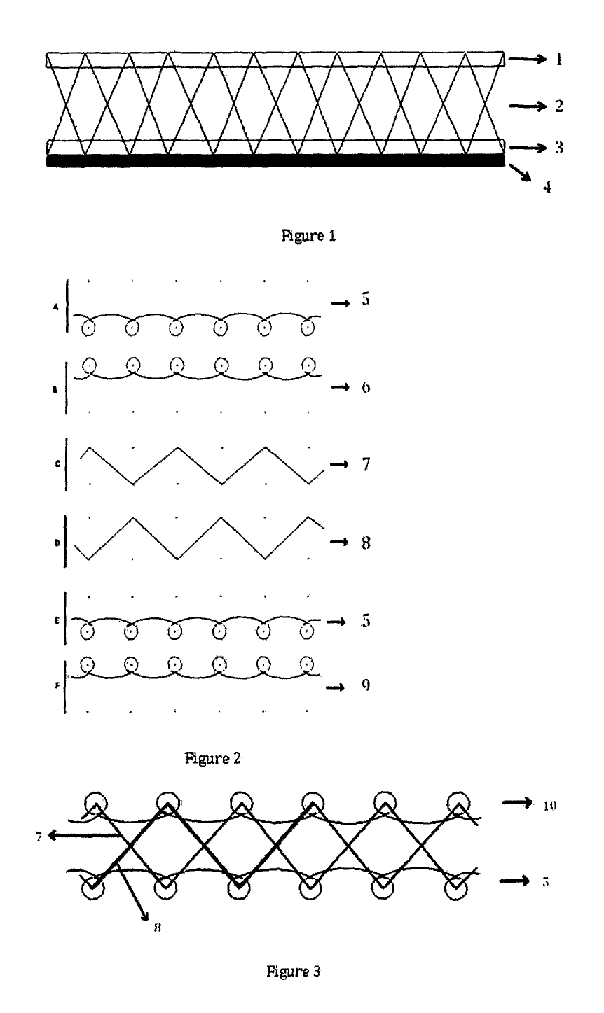

### DETAILED DESCRIPTION

The present invention relates to a three-dimensional (3D) multifunctional knitted structure comprising an inner knitted layer, an outer knitted layer, connecting cross-threads and a coated/laminated film on the outer layer. The 3D structure, besides the coated/laminated film, is integrally and in a single step produced on a flat or circular knitting machine using a special combination of loops performed both on the dial and on cylinder, in the case of circular knitting, and on the front and back needle bed, in the case of flat knitting technology. This special combination of loops enables the possibility of producing two separate layers (inner and outer) connected by a monofilament thread oriented in the thickness direction, giving the structure the three-dimensionality required for the application. The functionalities given to the structure are provided both from the fiber orientation in the structure itself and by the use of functional fiber yarns with special features. The orientation of fibers in the third dimension, perpendicular to the inner and outer layers, will act as capillaries to transport liquid from the inner to the outer layer. At the same time, these cross-threads will inhibit the separate structures (inner and outer) to get in contact which is quite important once the outer layer is wet due to urine absorption and the inner layer is dry. The three-dimensional (3D) multifunctional structure is especially designed to be used as an absorbent material in men's medium incontinence underwear providing the required characteristics of comfort and functionalities. The integration of the three-dimensional (3D) multifunctional structure in the underwear pants is provided by sewing, being placed in contact with the user's genital area.

The knitting cycle (FIG. 2) to produce the three-dimensional (3D) multifunctional knitted structure includes the following steps:

A—knitting the inner layer (5) in the cylinder (in the case of using a circular machine) or in the front needle bed (in the case of using a flat machine) by using a hydrophobic fiber yarn, preferably polyethylene, polyester or polyamide, using normal loops formed by the complete movement of each needle to catch the yarn in its highest position and to withdraw the loop in the lowest one; hydrophobic fiber yarns might also be texturized, multifilament or monofilament, in order to design the fabric stiffness, once monofilaments are stiffer than texturized or multifilament yarns, in a range from 2 to 200 tex; combinations of tuck and miss loops with normal loops may be also used in a range of loop length from 0,1 to 2 cm.

B—knitting the outer layer (6) in the dial (in the case of using a circular knitting machine) or in the back needle bed (in the case of using a flat knitting machine) by using a hydrophilic fiber yarn, preferably viscose, using normal loops in all the needles; hydrophilic fiber yarns might be texturized, multifilament or monofilament in a range from 2 to 200 tex; combinations of tuck and miss loops with normal loops may be also used in a range of loop length from 0,1 to 2 cm.

C—knitting the cross-threads (7) connecting the inner and the outer layers produced in the cylinder and in the dial, or in the front and back needle beds, respectively, using a monofilament yarns, preferably polyester, polyamide or polypropylene using tuck loops in alternate needles in both needle systems; texturized, and multifilament yarns might be also used in a range from 2 to 200 tex; combinations of tuck and miss loops with normal loops may be also used in a range of loop length from 0,1 to 10 cm; loops may be placed in all the needles, in the cylinder and in the dial, or in the front and back needle beds, or just in preselected needle.

D—knitting the cross-threads (8) connecting the inner and the outer layers produced in the cylinder and in the dial, or in the front and back needle beds, respectively, using a hydrophilic yarn, preferably viscose, cotton or other highly hydrophilic fibers using tuck loops in the needles that have not been working with the monofilament yarn in the previous step of the knitting cycle; texturized, and multifilament yarns might be also used in a range from 2 to 200 tex; combinations of tuck and miss loops with normal loops may be also used in a range of loop length from 0,1 to 10 cm.

E—knitting the inner layer (5) in the cylinder or in the front needle bed by using a hydrophobic fiber yarn, preferably polyethylene, using normal loops in all the needles; hydrophobic fiber yarns might also be texturized, multifilament or monofilament in a range from 2 to 200 tex; combinations of tuck and miss loops with normal loops may be also used in a range of loop length from 0,1 to 2 cm.

F—knitting the outer layer (9) in the dial or in the back needle bed by using an odor-control fiber yarn, using normal loops in all the needles; hydrophilic fiber yarns might be texturized, multifilament or monofilament in a range from 2 to 200 tex; combinations of tuck and miss loops with normal loops may be also used in a range of loop length from 0,1 to 2 cm.

The three-dimensional (3D) structure obtained, by the application of this knitting cycle and the use of the mentioned materials, is able to present the required features in terms of comfort and functionalities required to be applied as absorbent material in the production of men's medium incontinence underwear. The inner layer (5) produced with hydrophobic fiber based yarns and presenting some tuck loops of the hydrophilic connecting cross-threads is able to transport the urine giving, at the same time, the dry sensation to the user. The tuck loops of the hydrophilic cross-threads play a very important role in this function, as they will soak the urine while the hydrophobic fiber based yarns will be kept dry just conducting the liquid by capillarity. The cross-threads layer is produced with two different materials, a monofilament hydrophobic based yarn (7) and a hydrophilic fiber based yarn (8). This layer plays a very important role to keep the distance between both separate layers, giving the required three-dimensionality characteristic to the structure, by the action of the monofilament yarns, and to guarantee the required liquid transportation from the inner layer, in contact with the body, to the outer coated/laminated layer. The use of the monofilament yarn provides resilience, insulation and shock absorption permitting at the same time, by capillarity, the liquid to be conducted. The hydrophilic material based yarns, used in these connecting cross-threads, play an important role to absorb the liquid in the inner layer and at same time to transport it to the outer layer. The outer layer (6), produced with highly hydrophilic fiber based yarns, like viscose or cotton, plays an important role in liquid retention. Besides, combining these materials with other functional based fibers, like odor control fiber due to ammonia neutralization, it is possible to reduce the odor effect provided by the urine retention. A coated/laminated polyurethane film (4) placed over the outer layer, with a thickness ranging from 0,001 to 2 cm, gives the required impermeable characteristic to three-dimensional (3D) multifunctional fabric structure for men's incontinence underwear. The coated/laminated film is applied with a larger width than the three-dimensional (3D) fabric structure in order to enable the possibility to close its edges and promote the required impermeable characteristic to the whole structure. This extra coated/laminated layer may be turned over the edge of the three-dimensional (3D) structure or may be used as connecting element for a coated strip to place over the edge of the three-dimensional (3D) structure and the extra coated/laminated film.

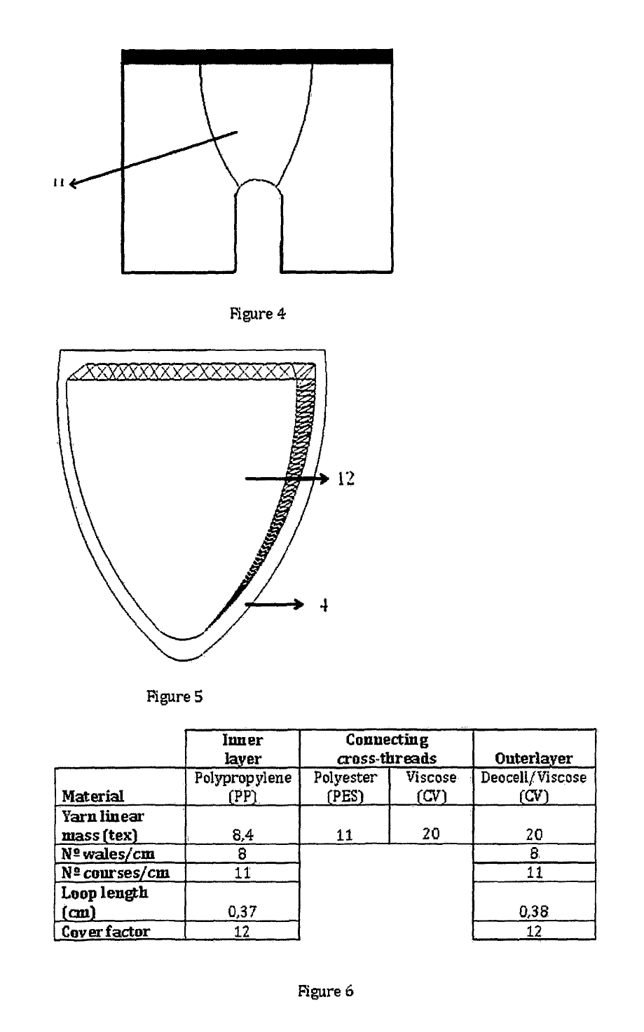

Different materials can be used to produce the three-dimensional (3D) multifunctional fabric. The variation in the type of fiber used can occur both in the inner and outer layers, and in the cross-threads, according to the requirements. The outer layer is preferably heavier than the inner layer in order to have enough fiber mass to retain all the urine required. This variation is feasible by varying the yarns parameters, like the linear mass, and the loop length. FIG. 6 gives the dimensional properties and the composition of the preferable three-dimensional (3D) multifunctional knitted fabric, wherein the thickness may vary from 0,1 to 6 cm according to the distance between dial and cylinder, in circular knitting machines, and, front and back needle beds, in flat knitting.

1. An integrated, washable and reusable three-dimensional (3D) multifunctional knitted fabric structure for men's incontinence underwear characterized by comprising:
an inner knitted layer (1);
an outer knitted layer (3);
and connecting cross-threads (2) between the inner and outer knitted layers.

2. An integrated, washable and reusable three-dimensional (3D) multifunctional knitted fabric structure, according to claim 1, characterized in that the inner knitted layer is a hydrophobic fiber based yarns (5).

3. An integrated, washable and reusable three-dimensional (3D) multifunctional knitted fabric structure, according to claim 1, characterized in that the outer knitted layer comprises a highly hydrophilic (6) and functional fiber based yarns (9).

4. An integrated, washable and reusable three-dimensional (3D) multifunctional knitted fabric structure, according to claim 3, characterized by a coated or laminated polyurethane film (4) placed over the outer knitted layer.

5. An integrated, washable and reusable three-dimensional (3D) multifunctional knitted fabric structure, according to claim 3, characterized by a coated or laminated film (4) placed over the outer knitted layer, wherein the film may be polyethylene, polypropylene or polyvinyl chloride.

6. An integrated, washable and reusable three-dimensional (3D) multifunctional knitted fabric structure, according to claim 4, characterized by the coated/laminated film thickness be in the range between 0,0001 cm and 2 cm.

7. An integrated, washable and reusable three-dimensional (3D) multifunctional knitted fabric structure, according to claim 1, characterized in that the connecting cross-threads (2) combine hydrophobic monofilaments (7) and hydrophilic (8) fiber based yarns between both layers.

8. An integrated, washable and reusable three-dimensional (3D) multifunctional knitted fabric structure, according to claim 1, characterized in that the yarns may be based on natural, artificial or synthetic polymers.

9. An integrated, washable and reusable three-dimensional (3D) multifunctional knitted fabric structure according to claim 1, characterized in that the yarns may be spun, texturized, multifilament or monofilament.

10. An integrated, washable and reusable three-dimensional (3D) multifunctional knitted fabric structure according to claim 1, characterized by the yarns linear mass be in the range between 2 and 200 tax.

11. A method of production of a three-dimensional (3D) multifunctional knitted fabric structure, characterized by the following cycling steps:
a) knitting the inner layer (5) in the cylinder in case of a circular machines or in the front needle bed in case of a flat knitting machines by using a hydrophobic fiber yarn, using normal loops formed by the complete movement of each needle to catch the yarn in its highest position and to withdraw the loop in the lowest one;
b) knitting the outer layer (6) in the dial, in case of a circular machines, or in the back needle bed, in case of a flat knitting machines, by using a hydrophilic fiber yarn, using normal loops in all the needles;
c) knitting the cross-threads (7) connecting the inner and the outer layers produced respectively in the cylinder and in the dial, in case of a circular machines, or in the front and back needle beds, in case of a flat knitting machines, using a monofilament yarns, using tuck loops in alternate needles in both needle systems;
d) knitting the cross-threads (8) connecting the inner and the outer layers produced respectively in the cylinder and in the dial, in case of a circular machines, or in the front and back needle beds, in case of a flat knitting machines, using a hydrophilic yarn, using tuck loops in the needles that have not been working with the monofilament yarn in the previous step of the knitting cycle;
e) knitting the inner layer (5) in the cylinder, in case of a circular machines, or in the front needle bed, in case of a flat knitting machines, by using a hydrophobic fiber yarn, using normal loops in all the needles;
knitting the outer layer (9) in the dial, in case of a circular machines, or in the back needle bed, in case of a flat knitting machines, by using an odor-control fiber yarn, using normal loops in all the needles.

12. A method of production of a three-dimensional (3D) multifunctional knitted fabric structure, according to claim 11, characterized by the use of more than one fiber based yarn type in the inner knitted layer.

13. A method of production of a three-dimensional (3D) multifunctional knitted fabric structure, according to claim 11, characterized by the use of more than one fiber based yarn type in the outer knitted layer.

14. A method of production of a three-dimensional (3D) multifunctional knitted fabric structure, according to claim 11, characterized by the use of more than one fiber based yarn type in the connection cross threads.

15. A method of production of a three-dimensional (3D) multifunctional knitted fabric structure, according to claim 11, characterized by the loops used to produce the inner knitted layer be combinations of tuck and miss loops with normal loops.

16. A method of production of a three-dimensional (3D) multifunctional knitted fabric structure, according to claim 15, characterized by the loop length in the inner knitted layer be in the range between 0,1 cm and 2 cm.

17. A method of production of a three-dimensional (3D) multifunctional knitted fabric structure, according to claim 11, characterized by the loops used to produce the outer knitted layer are combinations of tuck and miss loops with normal loops.

18. A method of production of a three-dimensional (3D) multifunctional knitted fabric structure according to claim 17, characterized by the loop length in the outer knitted layer be in the range between 0,1 cm and 2 cm.

19. A method of production of a three-dimensional (3D) multifunctional knitted fabric structure, according to claim 11, characterized by the loops used to produce the connecting threads be combinations of tuck and miss loops with normal loops.

20. method of production of a three-dimensional (3D) multifunctional knitted fabric structure, according to claim 19, characterized by the loop length in the connecting threads be in the range between 0,1 cm and 10 cm.

21. A method of production of a three-dimensional (3D) multifunctional knitted fabric structure, according to claim 20, characterized by the distance between inner and outer layers may vary from loop length used in the connecting threads in a range between 0,1 cm and 6 cm.

22. A method of production of a three-dimensional (3D) multifunctional knitted fabric structure, according to claim 11, characterized by the connecting threads just placed in preselected needles in the cylinder and dial, in case of circular knitting machines, or in the front and back needle beds, in case of flat knitting.
